(19) United States
(12) Patent Application Publication
(10) Pub. No.: US 2007/0088803 A1
(43) Pub. Date: Apr. 19, 2007

(54) Computer network information systems, query systems and methods thereof

(75) Inventors: Xin Hu, Shanghai (CN); Tai-Shui Ho, Shanghai (CN)

Correspondence Address: BIRCH STEWART KOLASCH & BIRCH, PO BOX 747, FALLS CHURCH, VA, 22040-0747, US

(73) Assignee: Inventec Appliances Corporation

(21) Appl. No.: 11/527,401

(22) Filed: Sep. 27, 2006

(30) Foreign Application Priority Data
Sep. 28, 2005 (TW) 94133794

(51) Int. Cl. G06F 15/16

(52) U.S. Cl. 709/217

(57) ABSTRACT

Computer network information systems, query systems and methods thereof to query a web address. The computer network information system comprises a client computer, a first host, a second host, and a plurality of remote devices coupled to the first host. The client computer transmits a query signal to the first host. The first host converts the query signal to a query code for transmission. The second host comprises a database, and comprises an update module for continuously updating the database. The second host receives the query code, and performs a match procedure to retrieve at least web address data. Respective remote devices include a website database providing website data, thereby providing more website data to the first host, and increasing query efficiency.

### BACKGROUND OF THE INVENTION

1. Field of the Invention

The disclosure relates generally to computer network information systems, query systems and methods thereof, and, more particularly to computer network information systems, query systems and methods thereof for querying a web address.

2. Description of the Related Art

As computer network information systems have grown, tree structures are employed to manage information therein. FIG. 1 illustrates such a tree structure of a conventional computer network information system. As shown, the top of the tree is root 11. The following level is country 12, such as tw, hk, and cn. Next is basic classification 13, such as com, org, edu, net, gov, and mil, followed by organization 14, such as ibm, microsoft, and intel, and finally host 15, such as www, mail, and ftp. A complete domain name comprises all the levels, such as “www.xyz.com.tw”, corresponding to one or several IP addresses.

The computer network information system receives IP addresses corresponding to domain names from a domain name server (DNS). However, the response time of a domain name server is limited by the capability of the computer network information system. Additionally, the usability of response varies with the packet loss rate of the computer network information system. FIG. 2 illustrates a standard query procedure of a conventional domain name server. As shown, a client computer 21 uses a web browser to transmit a query signal to a domain name server 22 (step 211). The domain name server 22 converts the query signal to a query code, checks whether web address data corresponding to the query code exists in a cache 23 (step 212). If so, the web address data is transmitted to the domain name server 22 (step 213), and returned to the client computer 21 (step 214). If not, the domain name server 22 transmits the query code to a first remote device 24 (step 215). The first remote device 24 returns the corresponding web address data to the domain name server 22 (step 216). The domain name server 22 copies the web address data to the cache 23 (step 217), and returns web address data to the client computer 21 (step 214).

FIG. 3 illustrates a “recurring” query procedure of a conventional domain name server. As shown in FIG. 3, a client computer 21 uses a web browser to transmit a query signal to a domain name server 22 (step 211). The domain name server 22 converts the query signal to a query code, and transmits the query code to a first remote device 24. At the same time, the domain name server 22 generates a message indicating “recurring query” is performed (step 311). If the first remote device 24 does not have the corresponding web address data, the first remote device 24 transmits the query code to a second remote device 32 among a plurality of remote devices 31 for querying web address data (step 312). At this time, the domain name server 22 is still waiting. If the second remote device 32 cannot discern the corresponding web address data, a message is returned to the first remote device 24 (step 313), directing the first remote device 24 to forward the query code to a third remote device 33 (step 314). If the third remote device 33 still cannot discern the corresponding web address data, a message is returned to the first remote device 24 (step 315), directing the first remote device 24 to forward the query code to another remote device. The process repeats until the corresponding web address data is found in a Nth remote device 34 (step 316). The web address data is returned to the first remote device 24 (step 317). The first remote device 24 returns the corresponding web address data to the domain name server 22 (step 318), and to the client computer 21 (step 214). It is noted that if the time of “recurring query” exceeds a threshold, a failure message is generated to the client computer. In the conventional computer network information system, the time for waiting “recurring query” is too long, and failure messages are easily generated.

### BRIEF SUMMARY OF THE INVENTION

Computer network information systems, query systems and methods thereof are provided.

An embodiment of a computer network information system comprises a client, a first host, a second host, and a plurality of remote devices coupled to the first host. The client transmits a query signal such as a domain name. The client comprises a web browser. The first host such as a region (country code) domain name server is coupled to the client, and converts the query signal to a query code such as an address for transmission. The address comprises numerals. The second host such as a local cache server comprises a database. The second host also comprises an update module for continuously updating the database. The second host receives the query code, and performs a match procedure to retrieve at least web address data. Respective remote devices such as remote domain name servers include a web site database providing web site data.

An embodiment of a query system receives a query signal such as domain name, and transmits the query signal to a remote device such as remote domain name servers for querying a web address. The query system comprises a first host and a second host. The first host such as a region domain name server receives the query signal, and converts the query signal to a query code such as an address for transmission. The address comprises numerals. The second host such as a local cache server comprises a database. The second host also comprises an update module for continuously updating the database. The second host receives the query code, and performs a match procedure to retrieve at least web address data.

In an embodiment of a method for querying a web address, a client uses a web browser to transmit a query signal such as a domain name. A first host such as a regional domain name server receives the query signal, converts the query signal to a query code such as an address, and transmits the query code to a second host such as a local cache server. The second host performs a match procedure according to the query code to retrieve at least web address data corresponding to the query code, and returns the web address data to the first host. The first host returns the web address data to the client.

Computer network information systems, query systems and methods thereof may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating a tree structure of a conventional computer network information system;

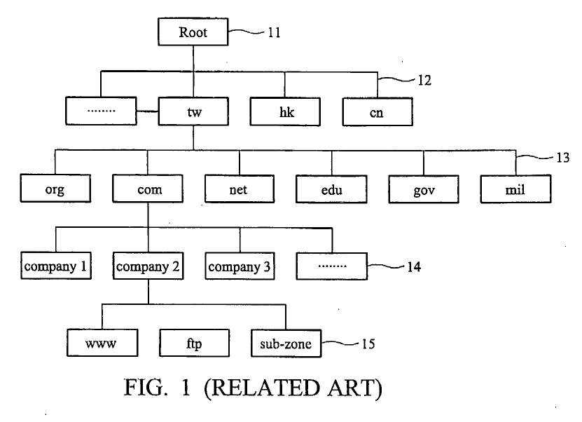

FIG. 2 is a schematic diagram illustrating a standard query procedure of a conventional domain name server;

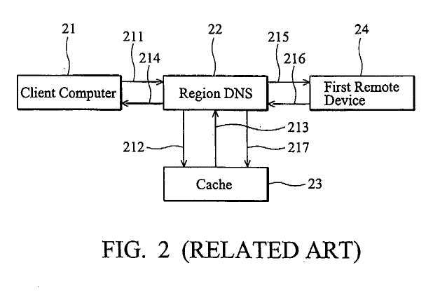

FIG. 3 is a schematic diagram illustrating a “recurring” query procedure of a conventional domain name server;

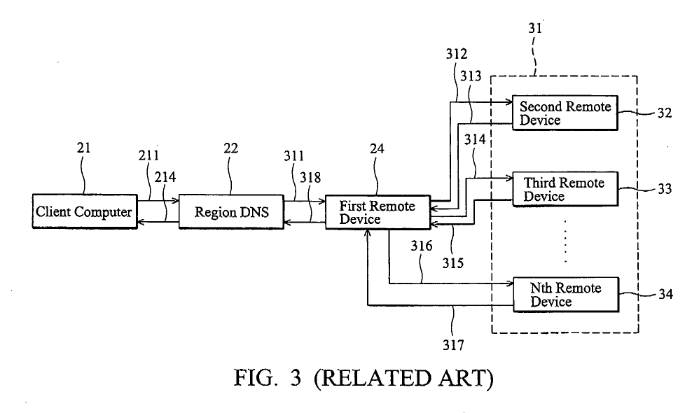

FIG. 4 is a schematic diagram illustrating an embodiment of a computer network information system according to the present invention;

FIG. 5 is a schematic diagram illustrating an embodiment of a query system according to the present invention;

FIG. 6 is a flowchart of an embodiment of a query method; and

FIG. 7 is a flowchart of an embodiment of an updating procedure of the second host.

### DETAILED DESCRIPTION OF THE INVENTION

Computer network information systems, query systems and methods thereof are provided.

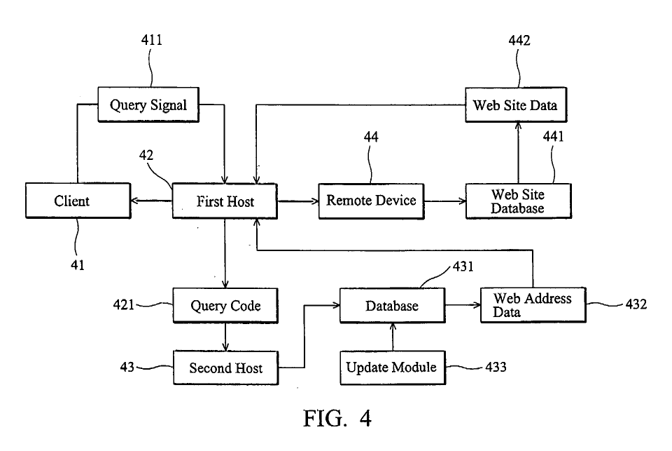

FIG. 4 is a schematic diagram illustrating an embodiment of a computer network information system according to the present invention. As shown in FIG. 4, the system comprises a client 41 such a computer, a first host 42, a second host 43, and a plurality of remote devices 44. The client computer 41 uses a web browser to transmit a query signal 411 to the first host 42 such as a domain name server. The first host 42 such as a regional (country code) domain name server converts the query signal to a query code 421 such as an address, and transmits the query code 421 to the second host 43. The second host 43, such as a local cache server, receives the query code 421, and performs a match procedure by comparing the query code 421 with a database 431, thereby retrieving at least web address data 432. The second host 43 transmits the web address data 432 to the first host 42. The second host 43 comprises an update module 433 for updating the database 431. The remote devices 44, such as remote domain name servers, receive the web address data 432 from the first host 42, and retrieve web site data 442 from a web site database 441 according to the web address data 432. The remote devices 44 transmit the web site data 442 to the first host 42, and to the client computer 41 via the first host 42.

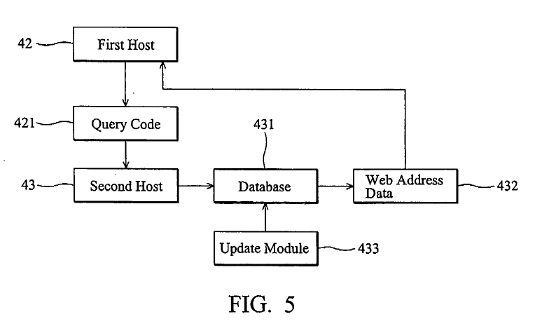

FIG. 5 is a schematic diagram illustrating an embodiment of a query system according to the present invention. The system receives a query signal such as domain name, and transmits the query signal to a remote device to query a web address. As shown in FIG. 5, the query system comprises a first host 42 and a second host 43. The first host 42 receives the query signal, and converts the query signal to a query code 421 such as an address comprising numerals for transmission. The second host 43 receives the query code 421, and performs a match procedure by comparing the query code 421 with a database 431, to retrieve at least web address data 432. The second host 43 transmits the web address data 432 to the first host 42. The second host 43 comprises an update module 433 for updating the database 431.

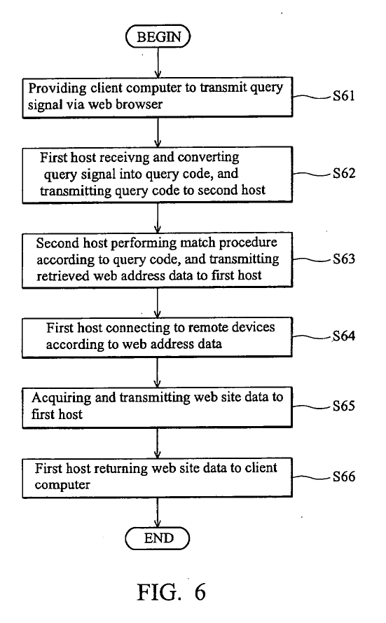

FIG. 6 is a flowchart of an embodiment of a query method. In step S61, a client computer is provided. The client computer uses a web browser to transmit a query signal. In step S62, a first host receives the query signal, converts the query signal to a query code, and transmits the query code to a second host. In step S63, a match procedure is performed according to the query code to retrieve at least web address data corresponding to the query code, and the web address data is returned to the first host. In step S64, the first host connects to a plurality of remote devices according to the web address data. In step S65, corresponding web site data is acquired and transmitted to the first host. In step S66, the web site data is returned to the client computer via the first host.

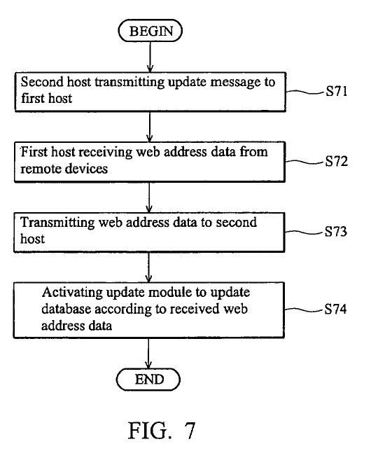

FIG. 7 is a flowchart of an embodiment of an updating procedure of the second host. In step S71, the second host transmits an update message to the first host. In step S72, the first host receives web address data from the remote devices. In step S73, the web address data is transmitted to the second host. In step S74, the update module is activated to update the database according to the received web address data. It is understood that the procedure is continuous, that is, the update module continuously updates the database according to any received data.

Computer network information systems, query systems and methods thereof, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A computer network information system, comprising:
a client transmitting a query signal;
a first host coupled to the client, receiving the query signal and converting the query signal to a query code for transmission;
a second host comprising a database and an update module to update the database, receiving the query code from the first host, and performing a match procedure according to the query code to retrieve at least a web address data; and
a plurality of remote devices coupled to the first host, respectively comprising a web site database providing web site data to the first host.

2. The system of claim 1 wherein the client comprises a computer.

3. The system of claim 2 wherein the computer comprises a web browser.

4. The system of claim 1 wherein the query signal comprises a domain name.

5. The system of claim 1 wherein the first host comprises a regional domain name server.

6. The system of claim 1 wherein the query code comprises an address.

7. The system of claim 6 wherein the address comprises numerals.

8. The system of claim 1 wherein the second host comprises a local cache server.

9. The system of claim 1 wherein the update module continuously updates the database.

10. The system of claim 1 wherein the remote devices comprise a remote domain name server.

11. A query system receiving a query signal and transmitting the query signal to a remote device for querying a web address, comprising:
a first host receiving the query signal, converting the query signal to a query code for transmission; and
a second host comprising a database and an update module to update the database, receiving the query code from the first host, and performing a match procedure according to the query code to retrieve at least a web address data.

12. The system of claim 11 wherein the remote device comprises a remote domain name server.

13. The system of claim 11 wherein the query signal comprises a domain name.

14. The system of claim 11 wherein the first host comprises a regional domain name server.

15. The system of claim 11 wherein the query code comprises an address.

16. The system of claim 15 wherein the address comprises numerals.

17. The system of claim 11 wherein the second host comprises a local cache server.

18. The system of claim 11 wherein the update module continuously updates the database.

19. A query method for querying a web address, comprising:
providing a client transmitting a query signal;
a first host receiving the query signal, converting the query signal to a query code, and transmitting the query code to a second host;
a second host performing a match procedure according to the query code to retrieve at least a web address data, and transmitting the web address data to the first host; and
the first host returning the web address data to the client.

20. The method of claim 19 wherein the client comprises a computer.

21. The method of claim 19 further comprising transmitting the query signal via a web browser.

22. The method of claim 19 wherein the query signal comprises a domain name.

23. The method of claim 19 wherein the first host comprises a region domain name server.

24. The method of claim 19 wherein the query code comprises an address.

25. The method of claim 24 wherein the address comprises numerals.

26. The method of claim 19 wherein the second host comprises a local cache server.
